(19) United States
(12) Patent Application Publication
(10) Pub. No.: US 2026/0101925 A1
(43) Pub. Date: Apr. 16, 2026

(54) COMBINATION SMOKING CADDY AND PHONE SUPPORT

(71) Applicant: Dan Beal, Baraboo, WI (US)

(72) Inventor: Dan Beal, Baraboo, WI (US)

(21) Appl. No.: 18/917,462

(22) Filed: Oct. 16, 2024

(51) Int. Cl. A24F 15/18; H04M 1/02

(52) U.S. Cl. CPC A24F 15/18; H04M 1/026

(57) ABSTRACT

A combination smoking caddy and phone support for supporting a smart phone has a caddy housing that is elongated along a longitudinal direction, extending from a base to a top end, the caddy housing having a first side surface, a second side surface, and a third side surface. A first magnet set is disposed on the first side surface, and a second magnet set disposed on the second side surface. A ferromagnetic plate having an adhesive layer is mounted to the smart phone, wherein the caddy housing can be magnetically attached to the smart phone via the ferromagnetic plate, such that the caddy housing supports the smart phone at a desired angle upon a support surface.

### BACKGROUND OF THE INVENTION

### Field of the Invention

This invention relates generally to smoking accessories, and more particularly to a combination smoking caddy and smart phone support, which can be used for not only carrying smoking related paraphernalia, but also for supporting a smart phone in a desired orientation.

### Description of Related Art

The prior art teaches smoking storage devices that are commonly used for storing and carrying smoking related paraphernalia; however, the prior art does not teach a smoking caddy that is also adapted to function as a stand for a smart phone. The present invention fulfills these needs and provides further advantages as described in the following summary.

### BRIEF DESCRIPTION OF THE DRAWINGS

The accompanying drawings illustrate the present invention.

FIG. 1 is a front perspective view of a combination smoking caddy and phone support according to one embodiment of the present invention;

FIG. 2 is a rear perspective view thereof;

FIG. 3 is a side elevational view of the combination smoking caddy and phone support shown resting upon a table surface 18 and positioned on a side surface of the combination;

FIG. 4 is another side elevational view of the caddy resting upon the table surface, showing the caddy resting upon a different side surface;

FIG. 5 is a perspective view of the combination smoking caddy and phone support in the position of FIG. 3, and further showing a ferromagnetic plate mounted on the smart phone, so that the smart phone in supported in a vertical orientation; and

FIG. 6 is a perspective view of the combination being used to support the smart phone in a horizontal orientation.

### DETAILED DESCRIPTION OF THE INVENTION

The above-described drawing figures illustrate the invention, a combination smoking caddy and phone support for supporting a smart phone on a support surface, such as a table surface.

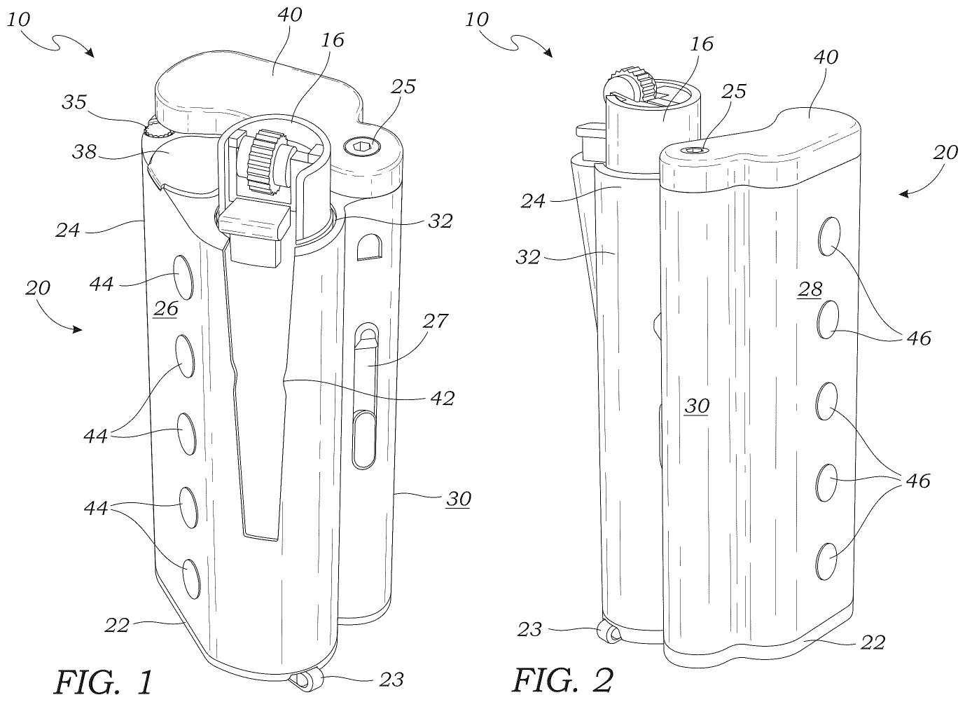

FIG. 1 is a front perspective view of a combination smoking caddy and phone support 10 according to one embodiment of the present invention. FIG. 2 is a rear perspective view thereof. As shown in FIGS. 1-2, the combination smoking caddy and phone support 10 includes a caddy housing 20. The caddy housing 20 is elongated along a longitudinal direction, extending from a base 22 to a top end 24, and has a first side surface 26, a second side surface 28, and a third side surface 30.
The caddy housing has at least one compartment for storing smoking paraphernalia. In this embodiment, the top end 24 includes openings for such compartments, in the form of a lighter receiving chamber 32 for storing a lighter 16, and a smoking product receiving chamber 34, each discussed below. In this embodiment, the smoking paraphernalia may include a lighter, any plants, herbs, or other items desired to be smoked, and any other materials known in the art that are of use to a smoker.
In some embodiments, an elongate cleaning tool 35 is adapted to be stored in a rod storage chamber 36, slot, or other suitable structure. A head 37 of the elongate cleaning tool 35 may be grasped to pull it from the caddy housing 20 for use. The smoking product receiving chamber 34 may include a first cap 38 for sealing smoking product (not shown) within the chamber. The top end 24 may further include a second cap 40 for covering additional openings, such as for a pipe receiving chamber (not shown), or additional smoking product storage chamber(s), or other chambers deemed useful by one skilled in the art. In some embodiments, the second cap 40 may pivot open via a screw 25, but in other embodiments, may be in the form of a resilient seal, or any other form of covering. The second cap 40 may also be openable via a switch 27, which can be pressed by a human thumb to “pop” the second cap 40 up for pivoting.

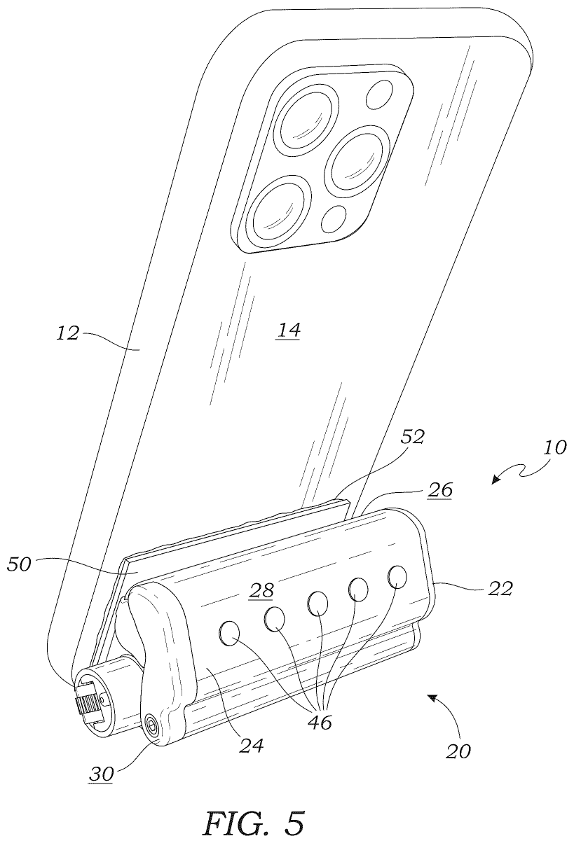

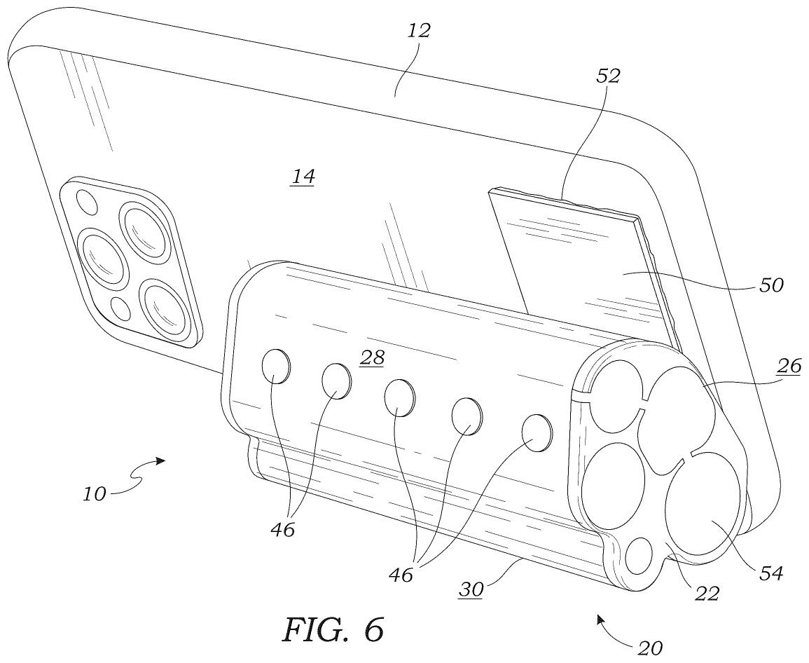

The smoking caddy and phone support 10 is adapted to store a plurality of smoking related supplies and accessories, and also adapted to be used as a stand for a smart phone 12. The smoking storage device is configured to enable supporting a smart phone 12 (as shown in FIGS. 5-6), and to enable easy use of the smoking related supplies and accessories, as discussed in greater detail below.

For the purposes of this application, the term “smart phone” may refer to any form of mobile phone or personal electronic device a user may wish to support upright, including but not limited to phones, tablet computers, handheld game consoles, etc.

In some embodiments, the caddy housing 20 is constructed of a rigid material, (e.g., plastic, metal, or other suitable material), but in other embodiments may be fully or partially constructed of semi-rigid material(s) (e.g., silicone, rubber, flexible plastic, etc.). The caddy housing 20 may further be an extruded construction, wherein the receiving chambers are cylindrical in shape, abut one another, and are arranged along axes which are all parallel with each other. In some embodiments, the lighter receiving chamber 32 may abut the other chambers, but has an offset-cylindrical cross-section that is sized and shaped to coincide with the shape of a typical lighter. However, other shapes may be formulated, to adapt to various types of accessories and storage needs. For example, a torch lighter may be used instead of a standard lighter, or any other related heating tool may be used. In this embodiment, the lighter 16 may be inserted into the lighter receiving chamber 32 where it frictionally engages the lighter receiving chamber 32 so that it does not fall out without intentional force being applied to overcome the frictional engagement.

As shown in FIGS. 1-2, the caddy housing 20 may include a slot 42 or aperture for a human thumb to directly push the lighter 16 upwardly. Alternatives may be implemented, e.g., a resilient plug that extends through an opening in the caddy housing 20 and into the lighter receiving chamber 32, and/or a tab/foot 23 adjacent the base 22 of the caddy housing 20 may similarly be used to push the lighter 16 upwardly out of the chamber, or any other similar alternatives for frictional disengagement. Furthermore, the lighter receiving chamber 32 may be configured to secure the lighter 16 without a snug/frictional fit, using any form of pin, lock, fastener, etc.

The smoking product receiving chamber 34 may be of different sizes and shapes to hold a desired quantity of the smoking product, and is adapted to keep the smoking product secure and protected against contamination, getting wet, drying out, etc. The smoking product may be in the form of any smoking product, e.g., cannabis flower, concentrates, waxes, resins, tobacco, etc., or other smokable materials. For the purposes of this application, the term “smoking” is defined to include any form of combusting or vaporizing an inhalable product, including marijuana, tobacco, and any other product known in the art.

As shown in FIGS. 1-2, a first magnet set 44 is disposed on the first side surface 26 of the caddy housing 20, and a second magnet set 46 is disposed on the second side surface 28. For the purposes of this application, the term “set” is hereby defined to mean “one or more,” so a single magnet in each set is within the scope of the claims as presented. A single magnet may be elongated, or rounded as illustrated, or any other shape deemed suitable by the manufacturer. In this embodiment, each magnet set 44 and 46 includes five magnets spaced along the longitudinal length of the caddy housing 20, but as stated, any number of magnets may be implemented.

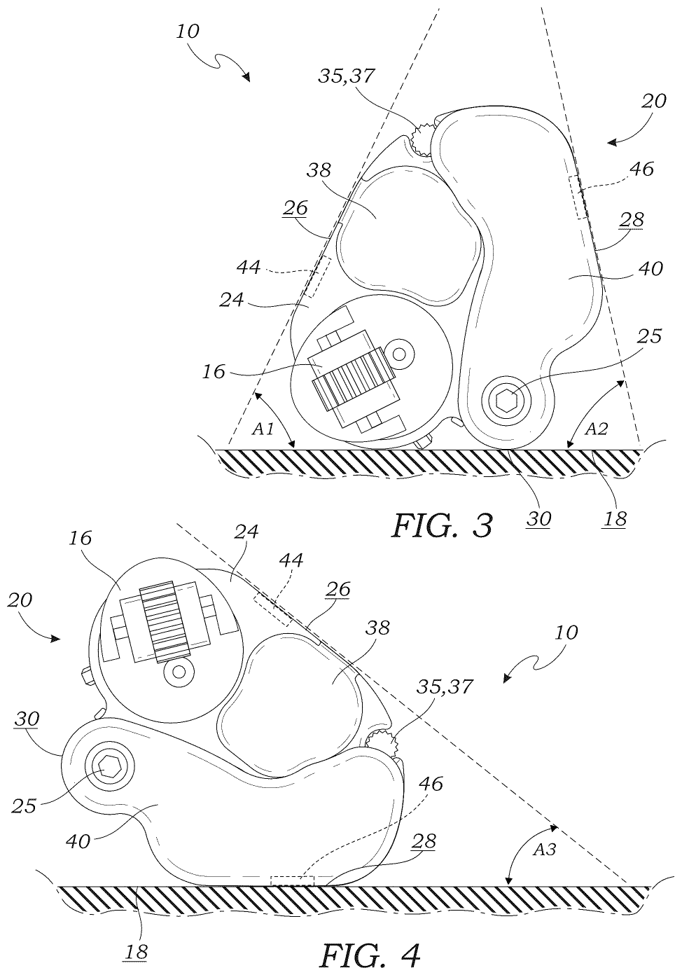

FIG. 3 is a side elevational view of the combination smoking caddy and phone support 10 shown positioned so that the third side surface 30 rests upon the support surface 18, so that first and second side surfaces are disposed on planes that extend at a first angle A1 and a second angle A2, and so that a longitudinal axis of the housing is horizontal.

For purposes of this application, the term “surface” is defined to include at least three points that together define a plane that may be used to support the combination 10 in a stable position. It may be a generally planar portion of the combination 10, or multiple parts which collectively support the combination 10 on the surface 18.

As illustrated, angle A1 is formed by the relative orientations of the planes of the first side surface 26 and the third side surface 30, and this is the angle at which a smart phone will be supported when in use, as shown in FIGS. 5-6. Similarly, angle A2 is formed between the second side surface 28 and the third side surface 30. Angles A1 and A2 are selected to be different angles that are preferable angles for a supported smart phone 12, discussed further below. In one embodiment, A1 is between approximately 50-80 degrees, and A2 is between approximately 95-120 degrees. Obviously, the caddy housing 20 may be constructed to form different angles, and the given measurements are provided only for the purpose of example.

FIG. 4 is a side elevational view of the combination smoking caddy and phone support 10, shown positioned on the second side surface 28 and illustrating the angle A3. As shown in FIG. 4, angle A3 is the angle formed between of the first side surface 26 and the second side surface 28. As illustrated, the first side surface 26 at the position A3 provides yet another angle for supporting the smart phone 12. In one embodiment, A3 is between approximately 130-160 degrees. As previously stated, other angles may be provided, according to the desires of the consumer.

FIG. 5 is a perspective view of the combination smoking caddy and phone support 10 in the position of FIG. 3, and further showing a ferromagnetic plate 50 mounted on the smart phone 12, so that the smart phone 12 in supported in a vertical orientation. The ferromagnetic plate 50 is mounted upon the smart phone 12 using any method known in the art, in this case via an adhesive layer 52, typically a rear surface 14 of the smart phone 12. Once the ferromagnetic plate 50 has been mounted to the smart phone 12, the caddy housing 20 can be magnetically attached to the smart phone 12 via a selected set of magnets being magnetically attached to the ferromagnetic plate 50, such that the caddy housing 20 supports the smart phone 12 at a desired angle upon the support surface 18 (shown in FIGS. 3-4). FIG. 5 illustrates the smart phone 12 in a vertical position, but the smart phone 12 could easily be rotated on its side, as shown in FIG. 6.

FIG. 6 is a perspective view of the combination smoking caddy and phone support 10 in the position of FIG. 3, with the smart phone 12 being supported thereupon. As shown in FIGS. 5-6, the smart phone 12 may be supported in a vertical or horizontal position. Furthermore, the ferromagnetic plate 50 may be mounted to any desired surface of the smart phone 12, for being supported by either the first or second side surface 28, in either of the configurations illustrated in FIGS. 3-6.

FIG. 6 also illustrates the base 22 of the caddy housing 20, showing a resilient insert 54. In some embodiments, the various chambers described above may be formed to extend all the way through the caddy housing 20, wherein the resilient insert 54 may be inserted to provide a bottom for each chamber.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A combination smoking caddy and phone support for supporting a smart phone, the combination comprising:
a caddy housing that is elongated along a longitudinal direction, extending from a base to a top end, the caddy housing having a first side surface, a second side surface, and a third side surface;
the caddy housing having at least one compartment for storing smoking paraphernalia;
a first magnet set disposed on the first side surface;
a second magnet set disposed on the second side surface;
a ferromagnetic plate having an adhesive layer;
wherein once the ferromagnetic plate has been mounted to the smart phone, the caddy housing can be magnetically attached to the smart phone via the ferromagnetic plate, such that the caddy housing supports the smart phone at a desired angle upon a support surface.

2. The combination smoking caddy and phone support of claim 1, wherein the top end includes openings into a lighter receiving chamber and a smoking product receiving chamber.

3. A method for supporting a smart phone on a support surface via a smoking caddy used to store smoking paraphernalia, the method comprising the steps of:
providing a combination smoking caddy and phone support comprising:
a caddy housing that is elongated along a longitudinal direction, extending from a base to a top end, the caddy housing having a first side surface, a second side surface, and a third side surface;
the caddy housing having at least one compartment for storing the smoking paraphernalia;
a magnet set disposed on the first side surface; and
providing a ferromagnetic plate;
mounting the ferromagnetic plate on the smart phone; and
attaching the caddy housing, magnetically, to the smart phone via the ferromagnetic plate, such that the caddy housing supports the smart phone at a desired angle upon a support surface.

4. The method of claim 3, wherein the caddy housing further includes a second magnet set disposed on the second side surface.
